(19) United States
(12) Patent Application Publication
(10) Pub. No.: US 2007/0118717 A1
(43) Pub. Date: May 24, 2007

(54) Information processing apparatus and memory address space assignment method

(76) Inventor: Toshitaka Sanada, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/602,115

(22) Filed: Nov. 20, 2006

(30) Foreign Application Priority Data
Nov. 21, 2005 (JP) 2005-335933

(51) Int. Cl. G06F 12/00

(52) U.S. Cl. 711/173

(57) ABSTRACT

According to on embodiment, an information processing apparatus includes a memory comprising a first area and a second area, the second area comprising alternatively a first type of memory address space or a second type of memory address space depending upon a designation set by the apparatus user, and an assignment unit configured to assign the second area to be one of either type of memory address space as selected by the user.

### CROSS-REFERENCE TO RELATED APPLICATIONS

This application is based upon and claims the benefit of priority from Japanese Patent Application No. 2005-335933, filed Nov. 21, 2005, the entire contents of which are incorporated herein by reference.

### BACKGROUND

1. Field

One embodiment of the present invention relates to an information processing apparatus capable of assigning a main memory and an I/O device to a memory address space, and a memory address space assignment method for use in the information processing apparatus.

2. Description of the Related Art

In recent years, various types of portable information processing apparatuses, such as notebook personal computers, have been developed. This type of computer is configured such that an I/O device, for instance, is connectable, where necessary, to the computer in order to extend its functions.

There is known an I/O device that functions as an MMIO (Memory-Mapped Input/Output). The I/O device functioning as the MMIO is assigned to the memory address space of a processor.

Jpn. Pat. Appln. KOKAI Publication No. 2003-99388 discloses a computer system which supports MMIO.

Normally, in a system supporting MMIO, it is necessary to map an MMIO space, as well as a space for assignment of a main memory, to memory addresses of a processor.

In the meantime, in a 32-bit processor, the size of the memory address space, to which the 32-bit processor is accessible, is limited to 4 GB. Thus, in the case where a 4-GB physical memory is mounted on a computer, the memory size, which is actually usable as a main memory, is limited to a size that is obtained by subtracting the size of the MMIO address space from the 4 gigabytes. If the size of the MMIO address space is reduced, the memory size that is usable as the main memory increases. In this case, however, the I/O device, which is to function as MMIO, may not normally operate.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the external appearance of an information processing apparatus according to an embodiment of the present invention;

FIG. 2 is an exemplary block diagram showing an example of the system configuration of the information processing apparatus shown in FIG. 1;

FIG. 3 is a exemplary view for explaining an example of the structure of the memory address space of a CPU, which is provided in the information processing apparatus shown in FIG. 1;

FIG. 4 is an exemplary view for explaining another example of the structure of the memory address space of the CPU, which is provided in the information processing apparatus shown in FIG. 1;

FIG. 5 is an exemplary view for explaining a state in which a display device displays a BIOS setup menu screen which is executed by the information processing apparatus shown in FIG. 1;

FIG. 6 is an exemplary view for explaining a state in which a memory is assigned to the memory address space of the CPU 111 in accordance with an operation mode which is set by the information processing apparatus shown in FIG. 1;

FIG. 7 is an exemplary flow chart illustrating an example of the procedure of a memory address space assignment process which is executed by the information processing apparatus shown in FIG. 1;

FIG. 8 is an exemplary flow chart illustrating a first example of the procedure of a memory resource priority setting process which is executed by the information processing apparatus shown in FIG. 1;

FIG. 9 is an exemplary first flow chart illustrating a second example of the procedure of the memory address space assignment process which is executed by the information processing apparatus shown in FIG. 1; and

FIG. 10 is an exemplary second flow chart illustrating the second example of the procedure of the memory address space assignment process which is executed by the information processing apparatus shown in FIG. 1.

### DETAILED DESCRIPTION

Various embodiments according to the invention will be described hereinafter with reference to the accompanying drawings. In general, according to one embodiment of the invention, an information processing apparatus comprises a memory comprising a first area and a second area, the second area comprising alternatively a first type of memory address space or a second type of memory address space depending upon a designation set by the apparatus user, and an assignment unit configured to assign the second area to be one of either type of memory address space as selected by the user.

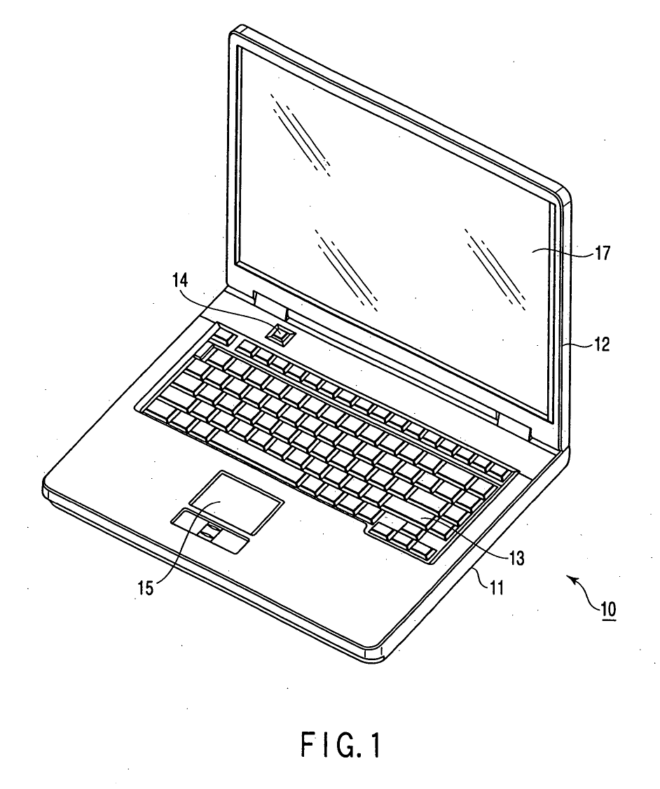

FIG. 1 shows the structure of an information processing apparatus according to an embodiment of the present invention. The information processing apparatus is realized, for example, as a battery-powerable notebook-type mobile personal computer 10. The notebook-type mobile personal computer 10 is configured such that various I/O devices (option I/O devices), such as a USB (Universal Serial Bus) device, a CardBus card device supporting the CardBus standard, a PCIExpress card device supporting the PCIExpress (Peripheral Component Interconnect Express) standard, are removably connectable to the personal computer 10.

The computer 10 comprises a computer main body 11 and a display unit 12. A keyboard 13, a power button 14 for powering on/off the computer 10, and a touch pad 15 are disposed on the top surface of the computer main body 11. A connection port for connection to the above-mentioned option I/O device is disposed, for example, on the rear surface of the main body 11. A display device that is composed of an LCD (Liquid Crystal Display) 17 is built in the display unit 12. The display screen of the LCD 17 is positioned at an approximately central part of the display unit 12. The display unit 12 is supported on the main body 11 such that the display unit 12 is freely rotatable between an open position where the top surface of the main body 11 is exposed and a closed position where the top surface of the main body 11 is covered.

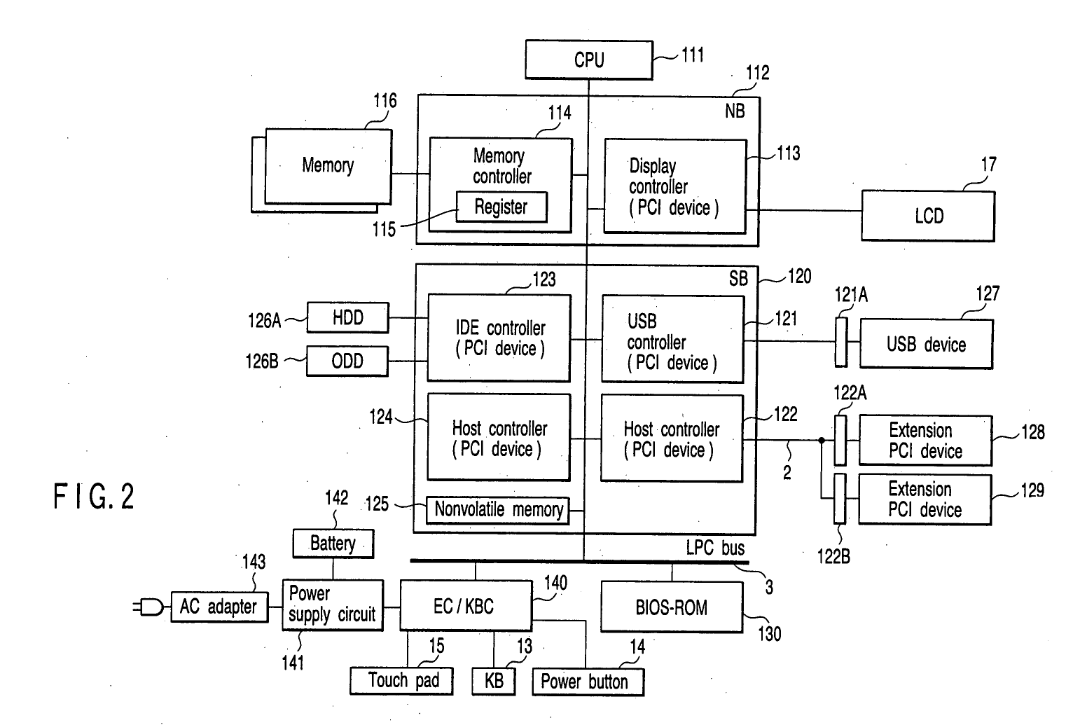

FIG. 2 shows an example of the system configuration of the computer 10.

The computer 10, as shown in FIG. 2, comprises a CPU 111, a north bridge (NB) 112, a main memory 116, a south bridge (SB) 120, a hard disk drive (HDD) 126A, an optical disc drive (ODD) 126B, a BIOS-ROM 130, and an embedded controller/keyboard controller IC (EC/KBC) 140.

The CPU 111 is a processor that controls the operation of the components of the computer 10. The CPU 111 executes an operating system (OS) and various application programs, which are loaded from the HDD 126A into the main memory 116. The CPU 111 also executes a system BIOS (Basic Input/Output System) that is stored in the BIOS-ROM 130. The system BIOS is a program for hardware control. The system BIOS has a function of displaying on the LCD 17 a BIOS setup menu screen for setting an operational environment of each component of the computer 10. The CPU 111 is realized, for example, as a 32-bit processor, and can access a memory address space of 4 GB. A standard memory area and an MMIO area are mapped in the memory address space. A physical memory, which is used as the main memory 116, can be assigned to the standard memory area. An I/O device, such as an MMIO (Memory-Mapped Input/Output), can be assigned to the MMIO area.

The north bridge 112 is a bridge device that connects the CPU 111 and the south bridge 120. The north bridge 112 includes a display controller 113 and a memory controller 114.

The display controller 113 functions as a PCI device and controls the LCD 17 which is used as a display monitor of the computer 10. The display controller 113 includes a video memory. On the basis of video data stored in the video memory, a display signal that is to be sent to the LCD 17 is generated.

The memory controller 114 is a controller which controls the main memory 116. The memory controller 114 includes a register 115. In the register 115, for example, the system BIOS sets address information for designating an area within the memory address space (i.e. a first address of the area and a last address of the area) to which the main memory 116 can be assigned. If memory address values, which are output from the CPU 111, belong to the area that is designated by the address information set in the register 115, the memory controller 114 accesses the main memory 116.

The main memory 116 is composed of a physical memory such as a DRAM (Dynamic Random Access Memory). Not only a memory module built in the main body 11, but also an extension memory module connected to the main body 11, is usable as the physical memory.

A PCI bus 2 and a LPC (Low Pin Count) bus 3 are connected to the south bridge 120. The south bridge 120 includes a USB controller 121, host controllers 122 and 124, an IDE controller 123 and a nonvolatile memory 125.

The USB controller 121 functions as a PCI device. The USB controller 121 is connected to a USB port 121A. The USB port 121A is a connection port to which a USB device 127, for instance, supporting the USB standard is connectable. The USB controller 121 controls an option I/O device, such as USB device 127, which is connected to the USB port 121A.

The host controller 122 functions as a PCI device and is connected to extension bus slots 122A and 122B. The extension bus slots 122A and 122B are configured such that option I/O devices, such as a CardBus card device and a PCIExpress card device, are connectable to the extension bus slots 122A and 122B.

The IDE (Integrated Drive Electronics) controller 123 functions as a PCI device and is connected to the HDD 126A and optical disc drive (ODD) 126B. The IDE controller 123 controls the HDD 126A and ODD 126B.

The nonvolatile memory 125 stores memory resource priority information. The memory resource priority information is stored in the nonvolatile memory 125 by the system BIOS. The memory resource priority information stored in the nonvolatile memory 125 is information indicative of one of operation modes: a memory size priority mode in which the main memory 116, in preference to the I/O device, is assigned to the memory address space of the CPU 111, and an extension device priority mode in which the I/O device, in preference to the main memory 116, is assigned to the memory address space of the CPU 111. The nonvolatile memory 125 also stores various setup information which is set on the BIOS setup menu screen.

The BIOS-ROM 130 and embedded controller/keyboard controller IC (EC/KBC) 140 are connected to the LPC bus 3.

The system BIOS that is stored in the BIOS-ROM 130 executes a memory address space assignment process according to the above-described memory resource priority information.

(1) Memory Size Priority Mode

In the case where the memory size of the physical memory mounted on the computer 10 is greater than the size of a standard memory area, the system BIOS assigns the physical memory to the standard memory area and a part of the MMIO area so that the memory size that is usable as the main memory 116 may become greater than the size of the standard memory area.

(2) Extension Device Priority Mode

In the case where the memory size of the physical memory mounted on the computer 10 is greater than the size of a standard memory area, the system BIOS assigns the physical memory only to the standard memory area so that the memory size that is usable as the main memory 116 may be limited to the size of the standard memory area.

The embedded controller/keyboard controller (EC/KBC) 140 is a 1-chip microcomputer in which an embedded controller for power management and a keyboard controller for controlling the keyboard (KB) 13 and touch pad 15 are integrated. The EC/KBC 140 has a function of cooperating with a power supply circuit 141 and powering on/off the computer 10 when the user presses the power button switch 14. The power supply circuit 141 generates operation power using power from a battery 142 or power supplied from an AC adapter 143.

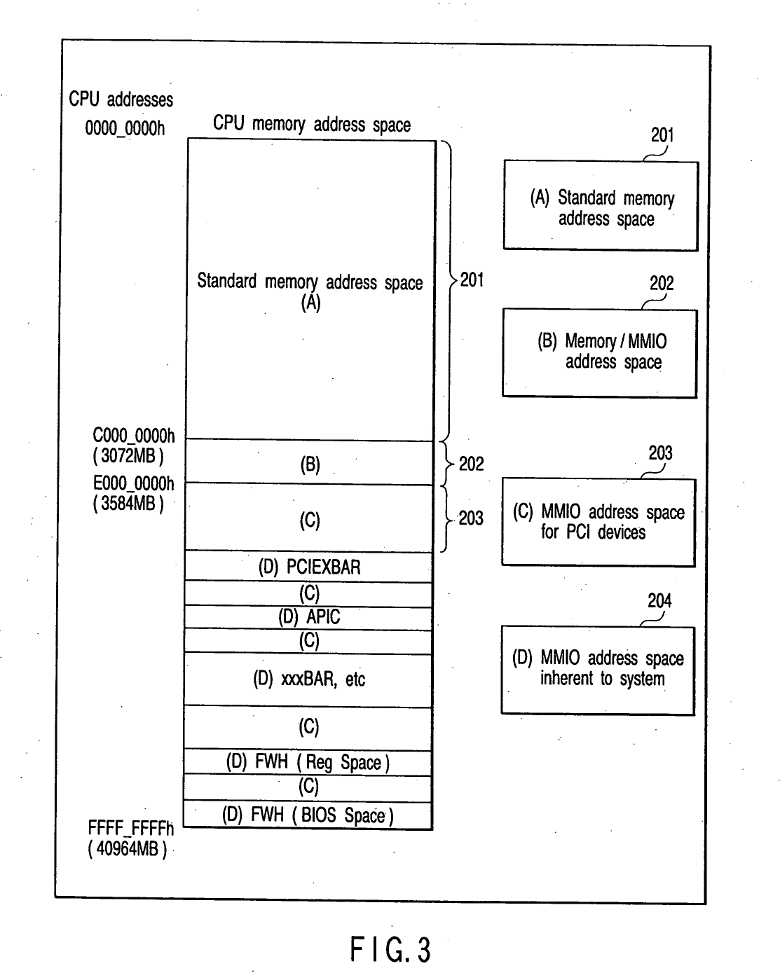

FIG. 3 shows an example of the structure of the memory address space of the CPU 111. In the memory address space, the following address spaces are mapped: (A) a standard memory address space 201, (B) a memory/MMIO address space 202, (C) an MMIO address space 203 for PCI devices, and (D) an MMIO address space inherent to the system.

The standard memory address space 201 is a memory address space to which the main memory 116 that is readable/writable by the CPU 111 can be assigned. The standard memory address space 201 is used as the above-mentioned standard memory area.

The memory/MMIO address space 202 is a memory address space that is usable as a memory address space, to which the main memory 116 can be assigned, or an MMIO address space to which the various option I/O device can be assigned. The memory/MMIO address space 202 is one of the above-mentioned MMIO memory areas, and is used for assignment of the I/O device such as the option I/O device.

The (C) MMIO address space 203 for PCI devices is a memory address area to which I/O devices, such as PCI devices within the computer 10, are assigned.

The (D) MMIO address space 204 inherent to the system is a memory address space to which components inherent to the computer 10 are assigned. For example, a PCIEXBAR (Peripheral Component Interconnect Express Base Address), an APIC (Advanced Programmable Interrupt Controller), an FWH (Firmware Hub) register space and an FWHBIOS (Firmware Hub BIOS) space are assigned to the MMIO address space 204 inherent to the system. The PCIEXBAR is an MMIO address space for access to a PCI config. register. The APIC is an MMIO address space for access to an interrupt controller. The FWH register space is an MMIO address space to which I/O registers within the BIOS-ROM 130 are assigned. The FWHBIOS space is an MMIO address space to which a flash memory within the BIOS-ROM 130 is assigned.

As is shown in FIG. 3, the 32-bit CPU can access only the 4 GB space from an address value 0000_0000h to an address value FFFF_FFFFh. In the computer 10, in order to activate the components of the computer 10 as described above, it is necessary to assign the PCI device, etc. to the MMIO address space 203, and to assign the PCIEXBAR, APIC, FWH register space and FWHBIOS space to the MMIO address space 204 inherent to the system. The memory space, which is obtained by subtracting the MMIO address space 204 inherent to the system, the MMIO address space 203 for PCI devices and the standard memory address space 201 from the entire 4 GB memory address space, becomes the memory/MMIO address space 202 which can be assigned to the option I/O device.

The CPU address range, which is mapped in the standard memory address space 201, is 0000_0000h to BFFF_FFFFh (0 MB to 3072 MB).

The CPU address range, which is mapped in the memory/MMIO address space 202, is C000_0000h to DFFF_FFFFh (3072 MB to 3584 MB).

In the memory size priority mode, the physical memory functioning as the main memory 116 can be assigned not only to the standard memory address space 201 but also to the memory/MMIO address space 202. Thus, the maximum memory size that is usable in the present system is the total memory size (about 3.5 GB) of the standard memory address space 201 and memory/MMIO address space 202.

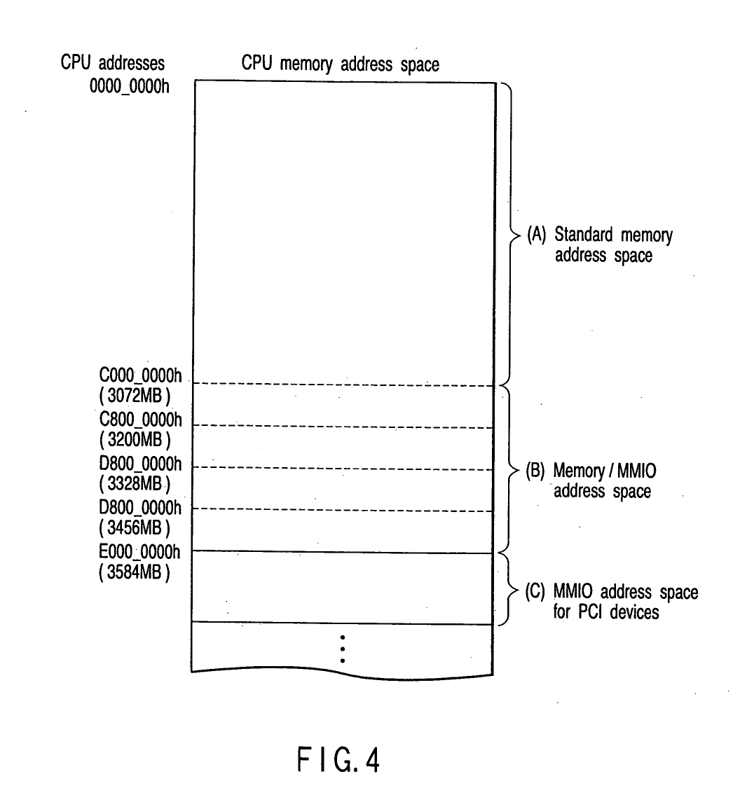

In the extension device priority mode, basically, the memory/MMIO address space 202 is used for assignment of the option I/O device. Thus, the maximum memory size that is usable in the present system is limited to the memory size (about 3.0 GB) of the standard memory address space 201. However, in the extension device priority mode, the following use is possible. That is, on the BIOS setup menu screen that is provided by the system BIOS, for example, the memory/MMIO address space 202 is divided into two areas. One of the two areas may be used as an extension area of the standard memory address space 201, and the other area may be used as the MMIO address space 202 for assignment of the option I/O device. As is shown in FIG. 4, the size of one of the two areas, which is used as the extension area, can be changed in units of 128 MB. Thus, in the extension device priority mode, the maximum memory size that is usable as the main memory 116 is one of 3072 MB, 3200 MB, 3328 MB and 3456 MB.

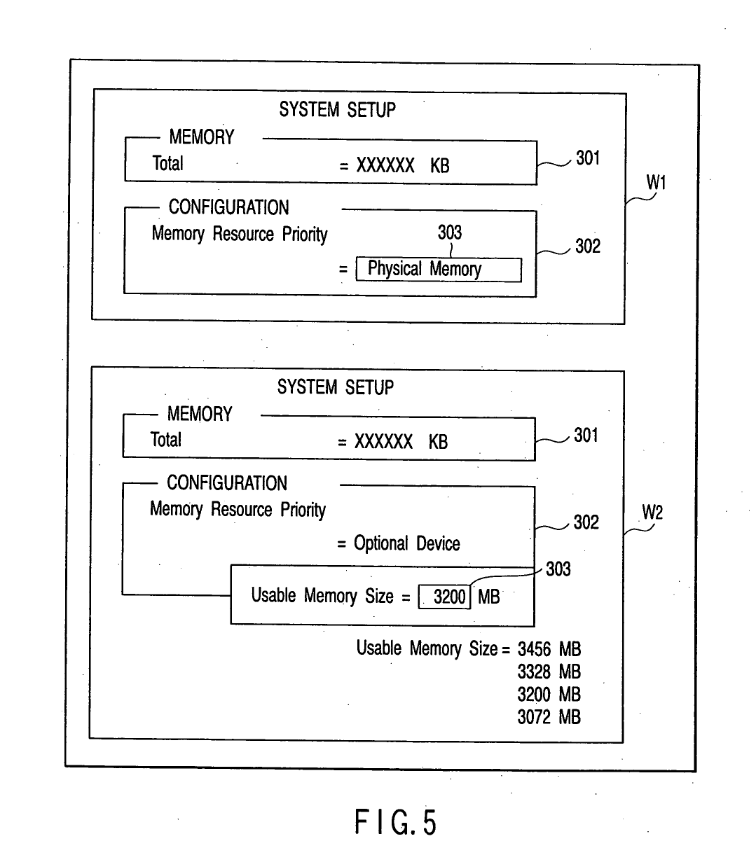

FIG. 5 shows an example of the BIOS setup menu screen. The BIOS setup menu screen is displayed on the LCD 17 by the system BIOS when a predetermined key (SET UP key) on the keyboard 13 is pressed during a power-on sequence of the computer 10.

The setup menu screen displays items 301 and 302. Item 301 indicates the actual memory size of the physical memory that is mounted on the computer 10. In other words, the item 301 indicates the total memory size of the memory size of the main memory 116 mounted on the computer 10 and the memory size of the extension memory module. The item 302 is an item for setting the content of the memory resource priority information. Using the item 302, the user can select, for example, one of “Physical Memory”, which indicates the memory size priority mode, and “Optional Device”, which indicates the extension device priority mode. Specifically, each time the user presses, e.g. the “↓” key on the keyboard 13 in the state in which a cursor 303 is located on “Physical Memory” of the memory resource priority, toggle display is effected in the order of “Optional Device”, “Physical Memory”, “Optional Device”, . . . A BIOS setup menu screen W1 shows an example in which the memory resource priority is set on “Physical Memory”. At this time, the operation mode of the computer 10 is set to the memory size priority mode.

If the user presses, for example, the enter key on the keyboard 13 in the state in which “Optional Device” is selected, an item “Usable Memory Size” is displayed, as shown in a BIOS setup menu screen W2. At this time, the cursor 303 is moved to “3200 MB”, which indicates the position where the memory size of “Usable Memory Size” item is designated. Each time the user presses, for example, the “↓” key on the keyboard 13 in the state in which the cursor 303 is located at “3200 MB” of the usable memory size item, toggle display is effected in the order of “3200 MB”, “3328 MB”, “3456 MB”, “3072 MB”, “3200 MB”, . . . If the usable memory size for the main memory 116 is designated at one of “3072 MB”, “3200 MB”, “3328 MB” and “3456 MB”, the memory/MMIO address space 202 is divided into two memory address spaces according to the designated memory size.

The system BIOS stores the memory resource priority information (memory size priority mode “Physical Memory”, extension device priority mode “Optional Device”), which is set on the BIOS setup menu screen, into the nonvolatile memory 125. If the extension device priority mode “Optional Device” is selected, the system BIOS stores the usable memory size (one of “3072 MB”, “3200 MB”, “3328 MB” and “3456 MB”), which is set on the BIOS setup menu screen, into the nonvolatile memory 125.

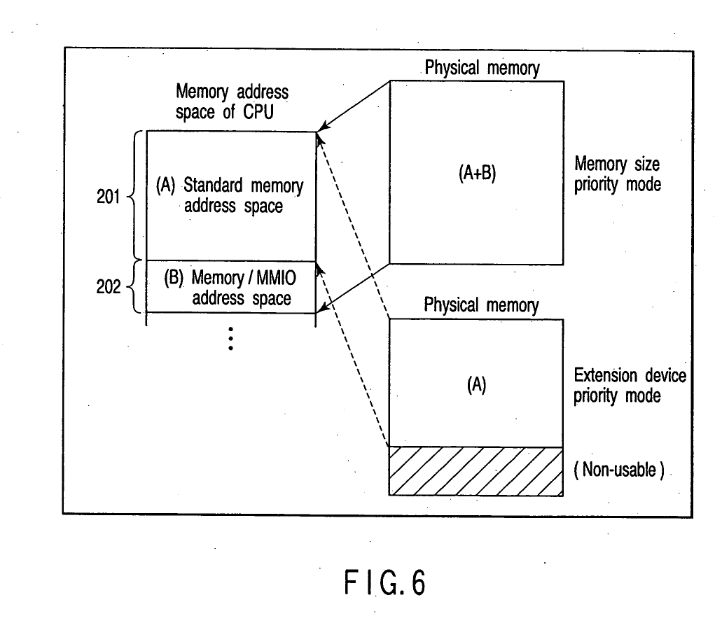

Next, referring to FIG. 6, a description is given of an example of the scheme of the memory address space assignment process for assigning the memory size of the physical memory to the memory address space of the CPU 111.

In the memory size priority mode, the system BIOS assigns the physical memory to both the standard memory address space 201 and the memory/MMIO address space 202. Thereby, the system BIOS sets the maximum memory size of the main memory 116 to the sum (3.5 GB) of the size of the standard memory address space 201 and the size of the memory/MMIO address space 202. In short, in the memory size priority mode, the total size (A+B) of the size of the standard memory address space 201 and the size of the memory/MMIO address space 202 becomes the maximum usable memory size.

In the extension device priority mode, the system BIOS assigns the physical memory only to the standard memory address space, thereby setting the maximum memory size of the main memory 116 to the size (3.0 GB) of the standard memory address space 201. The option I/O device can be assigned to the memory/MMIO address space 202.

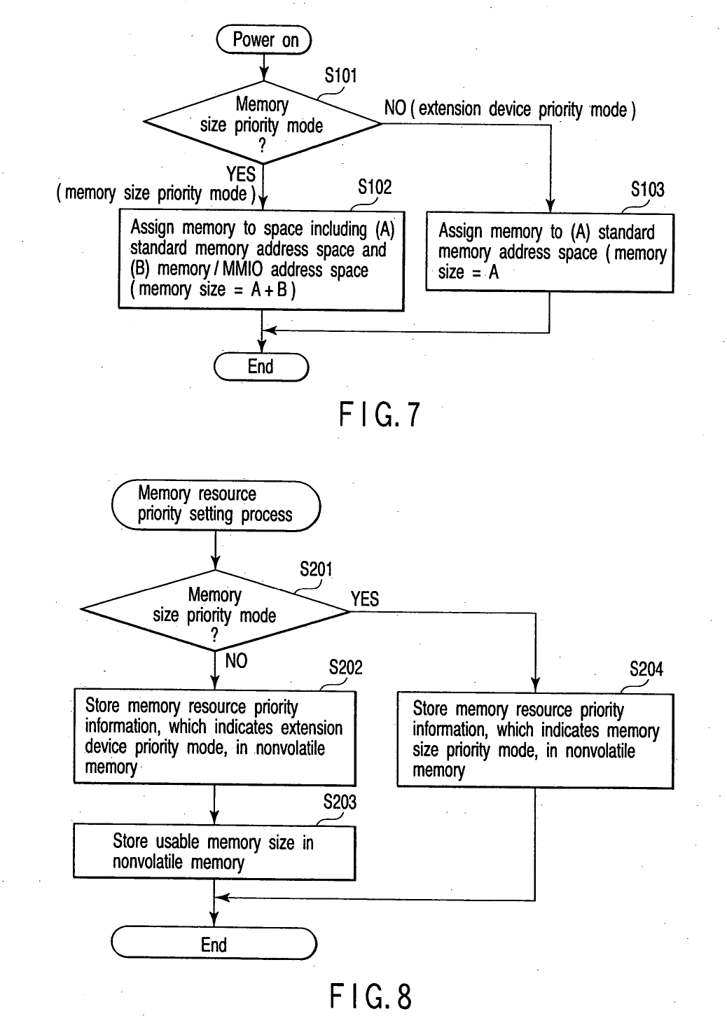

Next, referring to a flow chart of FIG. 7, a first example of the memory address space assignment process, which is executed by the system BIOS, is described. In the first example of the procedure of the memory address space assignment process, it is assumed, for example, that the size of the physical memory is 4 GB.

When the computer 10 is powered on, the system BIOS refers to the memory resource priority information, which is stored in the nonvolatile memory 125, and determines whether the memory size priority mode is designated or not (block S101). If it is determined that the memory size priority mode is designated (YES in block S101), the system BIOS executes a process of assigning the (A) standard memory address space 201 and (B) memory/MMIO address space 202 to the main memory 116 (block S102). In block S102, the memory size is set at a total value (3.5 GB) of the (A) standard memory address space 201 and (B) memory/MMIO address space 202.

On the other hand, if it is determined that the memory size priority mode is not designated, that is, if it is determined that the extension device priority mode is designated (NO in block S101), the system BIOS executes a process of assigning only the (A) standard memory address space 201 to the main memory 116 (block S103). In block S103, the memory size is set at a value (3.0 GB) of only the (A) standard memory address space 201.

In the first example of the memory address space assignment process, if the user designates the memory size priority mode, a physical memory of 3.5 GB at maximum can be used in the present system as the main memory 116. On the other hand, if the user designates the extension device priority mode, only a physical memory of up to 3.0 GB is usable, but the operation of the option I/O device, which is connected to the computer 10, can be ensured.

Next, referring to a flow chart of FIG. 8, an example of the procedure of the memory resource priority setting process, which is executed by the system BIOS, is described.

The system BIOS determines whether the operation mode of the computer 10 is the memory size priority mode or not (block S201). In block 201, the system BIOS determines whether the “Memory Resource Priority” item, which is set on the BIOS setup menu screen, is “Physical Memory” or not.

If it is determined that the memory size priority mode is not designated, that is, if it is determined that the extension device priority mode is designated (NO in block S201), the system BIOS stores memory resource priority information, which indicates the designation of the extension device priority mode, into, e.g. the nonvolatile memory 125 (block S202). Then, the system BIOS stores “Usable Memory Size”, which is set on the BIOS setup menu screen, into, e.g. the nonvolatile memory 125 (block S203).

On the other hand, if it is determined that the memory size priority mode is designated (YES in block S201), the system BIOS stores the memory resource priority information, which indicates the designation of the memory size priority mode, into the nonvolatile memory 125 (block S204).

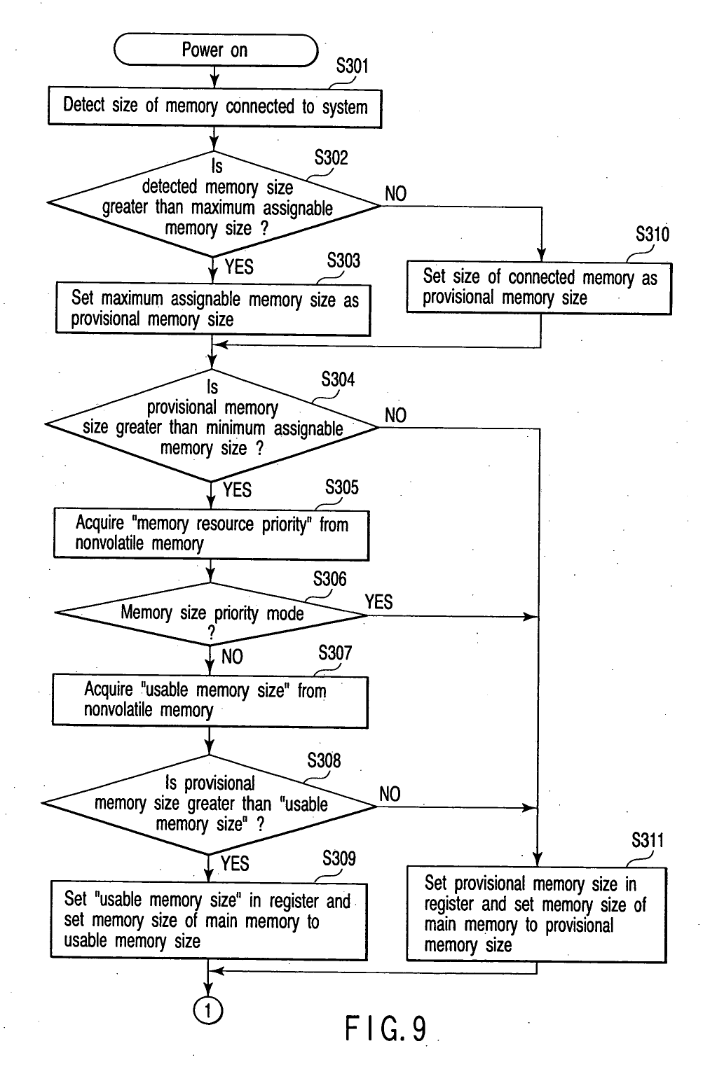

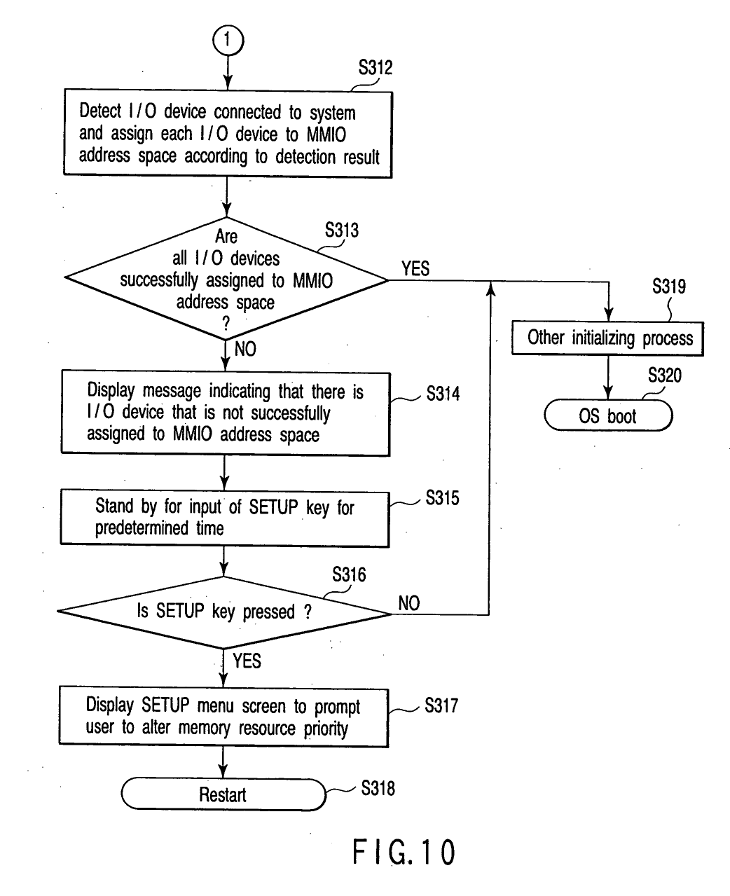

Next, referring to flow charts of FIG. 9 and FIG. 10, a second example of the memory address space assignment process, which is executed by the system BIOS, is described.

When the computer 10 is powered on, the system BIOS detects the memory size of the main memory 116, which is connected to the computer system (block S301). Specifically, in block S301, the system BIOS detects the memory size from an EEPROM (Electrically Erasable Programmable Read-Only Memory), such as SPD (Serial Presence Detect), provided in the main memory 116.

The system BIOS determines whether the detected memory size is greater than a maximum assignable memory size (block S302). In the present embodiment, the maximum assignable memory size is 3584 MB (about 3.5 GB). In block S302, it is determined, for example, whether the detected memory size is greater than 3.5 GB. If it is determined that the detected memory size is greater than the maximum assignable memory size (YES in block S302), the system BIOS sets the maximum assignable memory size as a provisional memory size of the main memory 116 (block S303). On the other hand, if the detected memory size is not greater than the maximum assignable memory size (NO in block S302), the system BIOS sets the detected memory size as a provisional memory size of the main memory 116 (block S310).

Following the execution of block S303 or block S310, the system BIOS determines whether the provisional memory size is greater than a minimum assignable memory size or not (block S304). In the present embodiment, the minimum assignable memory size is 3072 MB (about 3.0 GB). In block S304, it is determined, for example, whether the provisional memory size is greater than 3072 MB (about 3.0 GB). If it is determined that the provisional memory size is not greater than the minimum assignable memory size (NO in block S304), the system BIOS sets the provisional memory size in the register 115 of the memory controller 114, and sets the memory size of the main memory 116 at the provisional memory size (block S311). In block S311, the system BIOS stores the address information (first memory address and last memory address), which corresponds to the provisional memory size, in the register 115.

On the other hand, if it is determined that the provisional memory size is greater than the minimum assignable memory size (YES in block S304), the system BIOS acquires the memory resource priority information from the nonvolatile memory 125 (block S305).

Following the execution of block S305, the system BIOS determines whether the operation mode of the computer 10 is the memory size priority mode or not (block S306). In block S306, the system BIOS determines whether the acquired memory resource priority information indicates “Physical Memory” that represents the memory size priority mode. If it is determined that the memory size priority mode is designated, that is, if it is determined that the memory resource priority information is “Physical Memory” (YES in block S306), the system BIOS sets the provisional memory size in the register 115 of the memory controller 114 and sets the memory size of the main memory 116 at the provisional memory size (block S311). If the memory size of the physical memory is 4 GB, the memory size of the main memory 116 is set at 3.5 GB since the provisional memory size is 3.5 GB.

On the other hand, if it is determined that the memory size priority mode is not designated, that is, if it is determined that the memory resource priority is “Optional Device” (NO in block S306), the system BIOS acquires “Usable Memory Size” from the nonvolatile memory 125 (block S307). The system BIOS determines whether the provisional memory size is greater than the acquired usable memory size (block S308). If it is determined that the provisional memory size is not greater than the acquired usable memory size (NO in block S308), the system BIOS goes to block S311. On the other hand, if it is determined that the provisional memory size is greater than the acquired usable memory size (YES in block S308), the system BIOS sets the usable memory size in the register 115 of the memory controller 114 and sets the memory size of the main memory 116 at the usable memory size (block S309). In block S309, the system BIOS stores the address information (first memory address and last memory address) corresponding to the usable memory size in the register 115 of the memory controller 114.

Following the execution of block S309 or block S311, the system BIOS detects I/O devices, such as PCI devices, which are connected to the computer 10, that is, I/O devices such as PCI devices provided within the computer 10 and option I/O devices connected to the computer 10. On the basis of the detection result, the system BIOS executes a memory address assignment process for assigning the I/O devices to the MMIO address spaces (memory/MMIO address space 202, MMIO address space 203 for PCI devices and MMIO address space 204 inherent to the system) (block S312 in FIG. 10).

The system BIOS determines whether all I/O devices, which function as MMIOs, are successfully assigned to the MMIO address spaces (block S313). If it is determined that all I/O devices, which function as MMIOs, are successfully assigned to the MMIO address spaces (YES in block S313), the system BIOS executes an initializing process for other components, for example, by POST (Power-ON Self Test), and boots up the operating system (OS) (block S319, S320).

On the other hand, if it is determined that there is an I/O device which is not successfully assigned to the MMIO address spaces (NO in block S313), the system BIOS causes the LCD 17 to display a message indicating that there is an I/O device which is not successfully assigned to the MMIO address spaces (block S314). In block S314, the LCD 17 displays a message indicating the I/O device (PCI device, option device) which fails to be assigned to the MMIO address spaces and is not usable. The system BIOS stands by, for a predetermined time period, for the input of the BIOS setup start key (SET UP key) that designates the display of the BIOS setup menu screen (block S315). The system BIOS determines whether the SET UP key is pressed within the predetermined time period (block S316). If it is determined that the SET UP key is not pressed within the predetermined time period (NO in block S316), the system BIOS goes to block S319. In this case, the OS is booted up in the state in which the I/O device (PCI device, option device) that is not successfully assigned to the MMIO address spaces remains non-usable.

On the other hand, if it is determined that the SET UP key is pressed within the predetermined time period (YES in block S316), the system BIOS causes the LCD 17 to display, once again, the BIOS setup menu screen in order to prompt the user to alter the memory resource priority information (or to alter the usable memory size) (block S317). If the memory resource priority information is re-set by the user on the BIOS setup menu screen, the system BIOS stores the re-set memory resource priority information (also including the usable memory size in the extension device priority mode) in the nonvolatile memory 125, and reboots the computer 10. Then, the system BIOS goes to block S301 once again.

By the procedure from block S301 to block S311, the system BIOS sets the usable memory size in the computer 10.

As has been described above, in the second example of the memory address space assignment process, when the option I/O device priority mode is designated by the user, the user can alter the memory size of the standard memory address space and the memory size of the MMIO address space for PCI devices, which can be assigned to the physical memory. Thus, for example, when the I/O device, which is connected to the computer 10, is used, it is possible to assign the memory address space of the option I/O device so that the option I/O device may normally operate, and to maximize the standard memory address space 201 which can be assigned to the main memory 116.

The memory resource priority setting process in this embodiment is executed by the system BIOS. Alternatively, the memory resource priority setting process may be executed by software (e.g. OS, or an application program running on the OS) other than the system BIOS. That is, the memory resource priority setting process may be executed by this software even during a process sequence other than the power-on sequence of the computer 10.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a memory comprising a first area and a second area, the second area comprising alternatively a first type of memory address space or a second type of memory address space depending upon a designation set by the apparatus user; and
an assignment unit configured to assign the second area to be one of either type of memory address space as selected by the user.

2. The information processing apparatus according to claim 1, further comprising a designation unit configured to permit the apparatus user to designate a first setting corresponding to the first type of memory address space or a second setting corresponding to the second type of memory address space.

3. The information processing apparatus according to claim 2, where the first type of memory address space is standard memory address space.

4. The information processing apparatus according to claim 3, where the second type of memory address space is memory mapped input output (MMIO) address space.

5. The information processing apparatus according to claim 4, further comprising a second determination unit that is configured to determine whether the second area has enough address space for mapping I/O devices connected to the apparatus, and
an output unit configured to output a signal when the second area does not have enough space for mapping the I/O devices.

6. The information processing apparatus according to claim 2, wherein the designation unit that is configured to causes a display device to display a screen for prompting the apparatus user to select one of the first or second setting.

7. The information processing apparatus according to claim 1, wherein the second area comprises a first part configured to be designated a first type of memory address space and a second part configured to be designated a second type of memory address space.

8. The information processing apparatus according to claim 5, further comprising, a setting unit configured to set the size of the second area.

9. An information processing apparatus comprising:
a memory that has a predetermined physical memory space, including a first area as a main workable memory address space and a second area as a memory mapped input output(MMIO) address space; and
a assignment unit configured to assign the memory space of the first memory area from anywhere between a predetermined minimum memory space to a predetermined maximum memory space.

10. A method for assigning memory address space of a memory, the memory comprising a first area and a second area, the method comprising:
designating a desired memory address space mode from one of a plurality of types of memory address space;
assigning the second area of the memory to be the type of memory address space designated.

11. The method according to claim 10, wherein designating a desired memory address space mode comprises permitting a user to select a first setting corresponding to the first type of memory address space or a second setting corresponding to the second type of memory address space.

12. The method according to claim 11, where the first type of memory address space is standard memory address space.

13. The method according to claim 12, where the second type of memory address space is memory mapped input output (MMIO) address space.

14. The method according to claim 13, further comprising determining whether the second area has enough address space for mapping I/O devices connected to the apparatus, and sending an output signal when the second area does not have enough space for mapping the I/O devices.

15. The method according to claim 11, further comprising causing a display device to display a prompt for the user to select one of the first or second setting.

16. The method according to claim 14, further comprising, setting the size of the second area.
